(19) United States
(12) Patent Application Publication
(10) Pub. No.: US 2009/0017254 A1
(43) Pub. Date: Jan. 15, 2009

(54) FABRIC HAVING EMBEDDED DECORATIVE PATTERN

(76) Inventor: Manny Feldsohn, Hauppauge, NY (US)

Correspondence Address: DARBY & DARBY P.C., P.O. BOX 770, Church Street Station, New York, NY, 10008-0770, US

(21) Appl. No.: 12/172,823

(22) Filed: Jul. 14, 2008

Related U.S. Application Data
(60) Provisional application No. 60/949,827, filed on Jul. 13, 2007.

(51) Int. Cl. B32B 7/08; B32B 38/00

(52) U.S. Cl. 428/102; 156/93

(57) ABSTRACT

A decorative fabric having first and second layers includes decorative threads between the first and second layers. A stitching filament attaches the thread to the first layer. A second layer of thermoplastic sheet material is laminated to the first layer with the thread disposed therebetween.

### CROSS REFERENCE TO RELATED APPLICATION

The present application claims priority under 35 U.S.C. § 119(e) to U.S. Provisional Patent Application No. 60/949,827, which was filed on Jul. 13, 2007 and is hereby incorporated by reference herein in its entirety.

### FIELD OF INVENTION

This invention relates to fabric materials. More particularly, this invention relates to fabrics of rugged construction which include decorative patterns that significantly enhance the appearance of the fabric.

### BACKGROUND OF THE INVENTION

Fabrics today are used for innumerable purposes. The present invention relates to fabrics of the type which may be used to upholster furniture or which can be used for other relatively heavy duty applications such as luggage, shower curtains or the like. The invention provides a fabric, and a method of manufacturing a fabric, which may include many diverse decorative patterns and which, as a result, is more attractive than other similar fabrics with printed designs, which do not provide texture or result in a contrast of materials in the fabric that is aesthetically pleasing.

The purpose of the invention is to provide a heavy duty fabric which includes a decorative pattern that is formed by embedded yarns or threads which is aesthetically pleasing.

### SUMMARY OF THE INVENTION

A decorative heavy duty fabric comprises first and second layers of thermoplastic sheet material with at least one of the two layers being light transmissible. A decorative thread is placed on one layer of the two layers in a decorative pattern and secured to the layer by stitching filaments. After the decorative pattern has been stitched to the first layer, the second thermoplastic layer is laminated to the first layer, preferably by heat, to form a laminate in which the decorative pattern created by the decorative thread is secured between the two layers.

The decorative fabric has many uses and can be used in a variety of applications as a fabric material. For example, it can be used upholster furniture such as chairs and stools and other indoor or furniture. It can be used as a covering for pillows. The decorative fabric can be made into a shower curtain. The fabric can also be used to make accessories such as purses and handbags. The decorative fabric can be used to make tote bags. The fabric can also be used to make garments such as raincoats. The foregoing is only a partial list of the many uses for the decorative fabric.

### BRIEF DESCRIPTION OF THE FIGURES

FIG. 1 is a perspective view of a decorative fabric according to a preferred embodiment of the invention;

FIG. 2 is a partial front elevational view thereof;

FIG. 3A is a partial sectional view of the fabric taken along line 3-3 of FIG. 2 without the upper layer;

FIG. 3B is a partial sectional view of the decorative fabric taken along line 3-3 of FIG. 2 with the upper layer;

FIG. 4 is a partial sectional view of the decorative fabric taken along line 4-4 of FIG. 2;

FIG. 5 is a partial front elevational view showing the thread and stitching filaments; and

FIG. 6 is a perspective view of the upper and lower layers being laminated.

### DETAILED DESCRIPTION OF PREFERRED EMBODIMENT

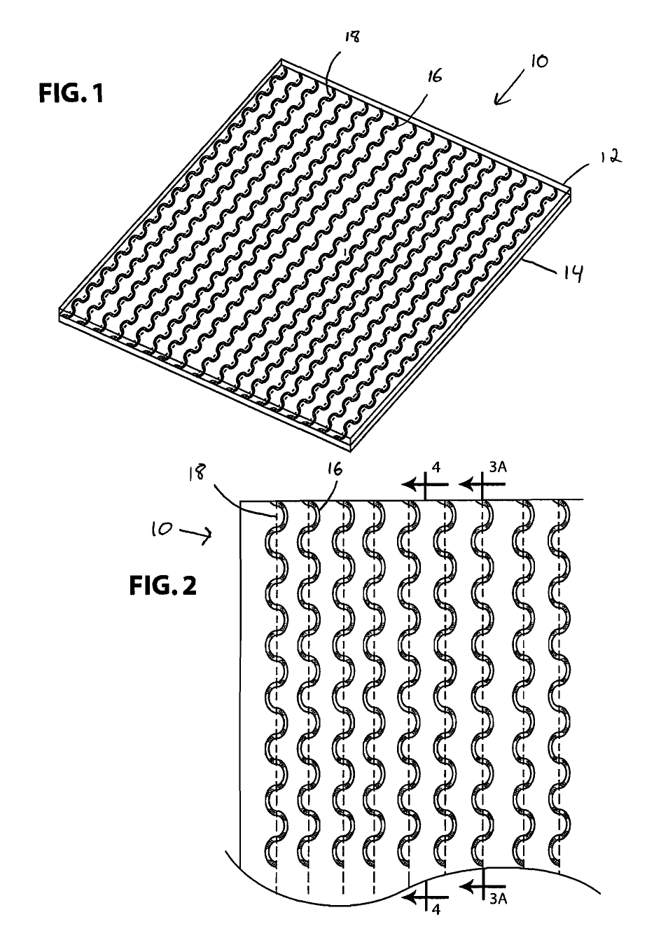

FIG. 1 is a perspective view of a preferred embodiment of the present invention. A heavy duty decorative fabric 10 is shown with decorative threads 16 provided in a undulating pattern. The fabric 10 includes a top layer 12 and a bottom layer 14 of sheet material. The top and bottom layers can be formed from various materials such as PVC, polyester, and other thermoplastic sheet materials. The top and bottom layers are preferably polyurethane. The top and bottom layers can be provided in varying thicknesses. The top and bottom layers are preferably provided as thin sheets and the top layer is preferably between about 0.22 millimeters to 0.28 millimeters thick and the bottom layer is preferably between about 0.17 millimeters to 0.23 millimeters thick. The decorative threads 16 are secured to bottom layer 14 by a stitching filament 18 to form a decorative pattern.

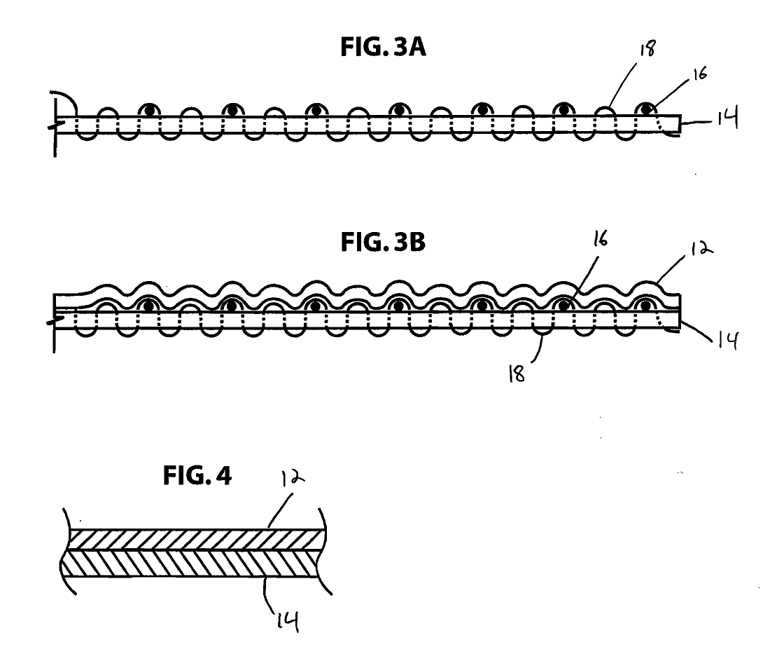

The decorative threads 16 can be placed on the sheet in a variety of different patterns in order to achieve a desired aesthetic effect and the invention contemplates any decorative pattern. The decorative threads 16 can be made of any suitable natural and/or synthetic material including cotton, polyester, rayon, and wool and can be provided in a variety of colors. The decorative threads 16 can also be yarns, which can be single color yarns or multicolor yarns to create different aesthetic effects, such as creating patterns similar to a tweed. The yarn can be loosely wound so that it blooms, i.e., the fibers that make up the yarn flare out. In addition, the decorative threads 16 can be relatively tightly wound to create more geometric patterns with narrower lines. The decorative threads 16 also provide a visual contrast between the texture of the threads, which can be a loosely wound yarn with its fibers flaring, and the top and bottom polyurethane layers 12, 14 between which they are embedded. Further, the fabric 10 has a textured surface which is caused by the top and bottom layers passing over the decorative threads 16. FIG. 3B shows the top layer 12 with a bumpy surface (which has been somewhat exaggerated for illustrative purposes) as the layer 12 passes over the decorative thread 16 and the stitching filament 18. In this example, the bottom layer 14 could also have a bumpy surface. FIG. 4 shows the top and bottom layers 12, 14 laminated together with relatively flat surfaces in areas where there are no decorative threads 16 or stitching filaments 18.

FIG. 3A is a cross-sectional view of the fabric 10 before upper layer 12 has been applied. As can be seen, stitching filament 18 passes through bottom layer 14 so that portions of the filament 18 are disposed on both sides of bottom layer 14. A conventional loop stitch may be used to secure the decorative threads 16 to layer 14. The stitching filament 18 can be made of any natural and/or synthetic material suitable for stitching threads including cotton and rayon. The stitching filament 18 can also be provided in a variety of colors and can be designed to be a part of the decorative design of the fabric or it can be designed so that it is less visible. For example, by selecting a stitching filament 18 that has the same color as the bottom layer 14 and that is relatively thinner than the decorative thread, the stitching filament 18 will be a less visible part of the aesthetic design of the fabric.

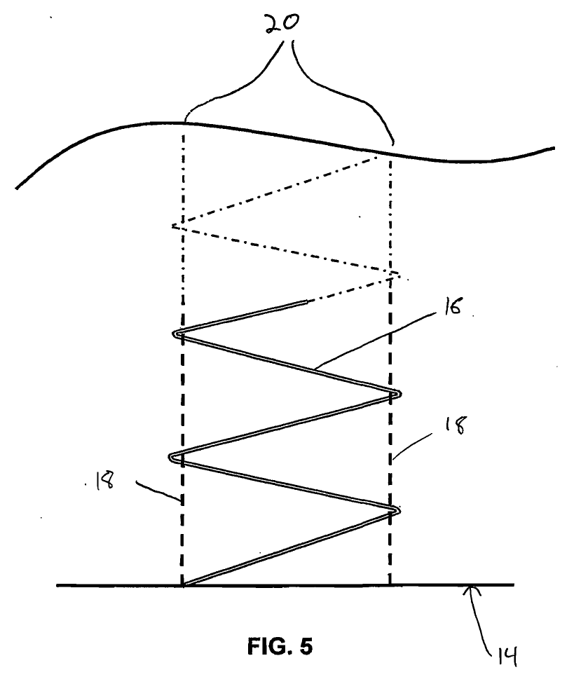

The fabric 10 is manufactured by feeding bottom layer 14 into a conventional mechanical crochet embroidery machine. The bottom layer 14 can be provided as a long sheet that has been spooled onto a roll so that it can be fed into the embroidery machine. As can be seen in FIG. 5, the stitching filaments 18 are stitched into layer 14 along a number of selected paths 20. These paths 20 run lengthwise of bottom layer 14. The decorative threads 16 are laid onto layer 14 so that as they are laid along the length of layer 14, they intersect the paths 20. FIG. 5 shows a thread 16 provided in a zigzag pattern wherein the thread 16 crosses between the path of two stitching filaments 18, which is different from the wavy pattern shown in FIG. 2, wherein the thread 16 undulates to cross the path of a single stitching filament 18. It is to be noted that any sort of decorative pattern can be used, and the examples are merely illustrative.

At the points where the decorative threads 16 intersect the stitch paths 20, the decorative threads 16 are secured to the bottom layer 14 by the stitching filaments 18. In FIG. 5, portions of the threads 16 and the stitching filaments 18 are shown in phantom to illustrate that as bottom layer 14 is fed into the embroidery machine, the threads 16 are being laid onto the bottom layer 14 and the stitching filaments 18 are also being progressively stitched into the bottom layer 14 by the embroidery machine to secure the threads 16 to the bottom layer 14. As discussed above, the decorative threads 16 can be laid on the bottom layer 14 in any decorative pattern.

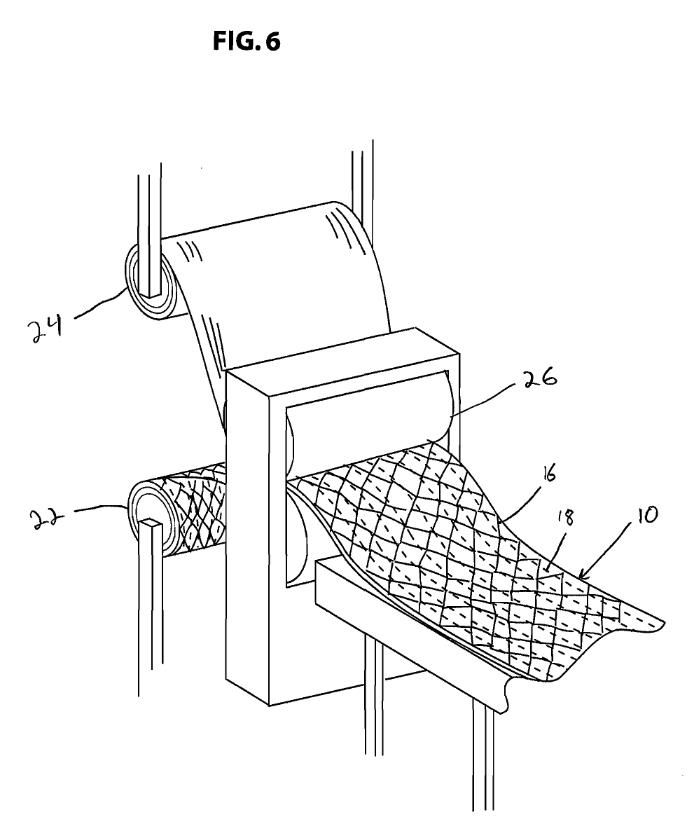

Once the decorative threads 16 have been laid on the bottom layer 14 and stitched into place to form the desired pattern, the top layer 12 is laminated to the bottom layer 16. As shown in FIG. 6, the decorative threads 16 (which are shown in a different decorative pattern than that shown in FIGS. 2 and 5) are preferably stitched onto long sheets of the bottom layer 14 so that bottom layer 14 with the threads 16 can be made into rolls of material 22. The top layer 12 is in the form of a long sheet that is provided as a roll 24. The fabric 10 is formed by passing the top layer 12 and the bottom layer 14 having the decorative threads 16 through calendar rollers 26. Heat is applied so that as the top and bottom layers pass through the rollers 26, the layers are fused together. Bottom layer 14 is oriented so that the decorative threads 16 face the top layer 12. Once the top and bottom layers 12, 14 are joined together, the decorative threads 16 are laminated between the two layers (FIG. 3B). The top and bottom layers are joined together in the areas where there are no threads or filaments (FIG. 4). The top and bottom layers may also be laminated together with an adhesive, or secured together in any other suitable fashion.

The decorative threads 16 are laminated between the top and bottom layers 12, 14 and therefore are protected from damage. The top layer 12 and the bottom layer 14 are made from translucent material so that light can pass through the material. Thus, the decorative threads 16 can be seen through the laminated layers. The bottom layer 14 may also be opaque and colored in order to add to the decorative effect of the decorative fabric 10. The top layer 12 may also be colored but it is preferable that the top layer is at least somewhat translucent.

While the invention has been particularly shown and described with reference to preferred embodiments thereof, it will be understood by those skilled in the art that various changes in form and details may be made therein without departing from the spirit and scope of the invention.

1. A decorative heavy duty fabric, comprising:
first and second layers of thermoplastic sheet material with at least one of the two layers being light transmissible; and
a decorative thread placed on the first layer in a decorative pattern and secured to the first layer by stitching filaments, the second thermoplastic layer being laminated to the first layer to form a laminate in which the decorative pattern created by the decorative thread is secured between the two layers.

2. A decorative heavy duty fabric according to claim 1, wherein the second thermoplastic layer is laminated to the first layer by heat.

3. A decorative heavy duty fabric according to claim 1, wherein a plurality of stitching filaments are stitched spaced apart from each other to form a plurality of substantially parallel spaced apart stitch paths.

4. A decorative heavy duty fabric according to claim 3, wherein the decorative thread extends between at least two stitch paths and is secured thereby.

5. A decorative heavy duty fabric according to claim 3, wherein a plurality of decorative threads are placed spaced apart from each other, each in an undulating pattern, and each decorative thread is secured by a single one of the stitch paths.

6. A decorative heavy duty fabric according to claim 1, wherein one of the layers is light transmissible and the other layer is opaque.

7. A decorative heavy duty fabric according to claim 1, wherein both of the layers are light transmissible.

8. A method of forming a decorative heavy duty fabric, comprising the steps of:
placing a decorative thread in a decorative pattern on a first layer of thermoplastic sheet material;
securing the decorative thread to the first layer by stitching filaments; and
laminating a second layer of thermoplastic sheet material to the first layer after the decorative thread has been placed and secured to the first layer to form a laminate in which the decorative pattern created by the decorative thread is secured between the two layers, and wherein at least one of the layers being light transmissible.
